(19) United States
(12) Patent Application Publication
(10) Pub. No.: US 2012/0078765 A1
(43) Pub. Date: Mar. 29, 2012

(54) Instant Financial Account Verification Using Direct Connect Data Communication Protocol And Open Financial Exchange Data-Stream Format

(75) Inventor: Santhosh Gopynadhan, Chennai (IN)

(73) Assignee: EBAY INC., San Jose, CA (US)

(21) Appl. No.: 12/891,687

(22) Filed: Sep. 27, 2010

(51) Int. Cl. G06Q 40/00

(52) U.S. Cl. 705/35

(57) ABSTRACT

A method for verifying a user's account, e.g., a checking account, at a financial institution, e.g., a bank, includes establishing a direct connection with the bank's account data server over a network, e.g., the Internet, using the Direct Connect peer-to-peer (P2P) file-sharing protocol and the Open Financial Exchange (OFX) data-stream format, sending a request to the account data server for a data file including data that verifies at least the existence and ownership of the user's account, and receiving a response from the account data server of a data file that includes data verifying at least the existence and ownership of the user's account at the financial institution.

### BACKGROUND

1. Field of the Invention

This disclosure generally relates to electronic commerce, and more particularly, to methods and apparatus for verifying a user's account at a third-party financial institution in a network environment.

2. Related Art

Beginning in about 1949, credit cards began to supplant cash and paper checks as a more convenient mechanism for transferring money between parties to a financial transaction, e.g., between a buyer and a seller in a sales transaction. During the succeeding 50 year period, large banks and credit card companies built a complex, proprietary and relatively closed system that currently handles about $2 trillion in credit card transactions and another $1.3 trillion in debit card transactions each year.

However, the credit card model that has developed is not without some drawbacks. Among these are the relatively large transaction costs involved, e.g., up to 3.5 per cent of a transaction, for a simple sale of goods or services, a delay in the time that it takes for the payee to receive funds, typically about 24-72 hours, and the need for the payee to have a credit card “reader” of some type and to pay a fee for its use. And, although many online vendors accept payment via credit card, many users, including both buyers and sellers, are uncomfortable with or unwilling to exchange credit card information with unknown parties.

As a result of the foregoing and other drawbacks, the last decade has seen the proliferation of a number of so-called alternative payment systems, such as PayPal, ING Electric Orange, Obopay, Yodlee, Amazon Payments, Xoom, Twitpay, and others, which act as trusted third-party or “intermediary” payment/collection service providers that effect money transfers directly between the parties' respective accounts via various data communication networks, including the Internet. These alternative payment systems bypass the complex credit card ecosystem to provide reduced transaction costs, typically by one-third of those charged vendors by credit card companies, effect immediate transfers of funds to and from the parties' respective accounts, and eliminate the need for credit card readers and their associated use fees. Today, about 20 percent of all online transactions take place over these alternative payment systems, and this number is expected to increase to nearly 30 percent during the next three years.

In order for a user, e.g., a buyer or a seller, to use the services of an alternative payment service provider, the user must first establish an account with that service provider, and if the service provider, acting on behalf of the user, is to withdraw funds from or deposit funds to a user's account at a third party financial institution, e.g., a bank, the service provider must first verify at least the existence and the user's ownership of that account.

Verification of a user's third-party deposit or credit account at a financial institution can be effected in a number of ways, including “random deposit account verification,” “instant account verification” and by way of third party, fee-for-service verification services. However, these systems can be slow and less secure, and in any case, are relatively expensive. A need therefore exists for systems for instantly verifying the existence and ownership of a user's account at a bank or other financial institution that are less complex and expensive and more secure than those of the prior art.

### SUMMARY

In accordance with the present disclosure, methods and apparatus, or systems, are provided for instantly verifying at least the existence and ownership of a user's account at a bank or other financial institution using networked computer processors which bypass the inefficiencies of the less secure conventional methods above by connecting directly to the bank's account data server using an open source peer-to-peer file-sharing protocol and a universally used open source financial data format.

In one embodiment, a method for verifying a user's account, e.g., a checking account, at a financial institution, e.g., a bank, includes using a service provider's data server to establish a direct connection over a network, e.g., the Internet, with the bank's account data server using the Direct Connect point-to-point (P2P) file-sharing protocol and the Open Financial Exchange (OFX) data-stream format, sending a request to the data server for a data file that includes data which verifies at least the existence and ownership of the user's account, and receiving a response from the data server over the network of a data file including data verifying at least the existence and ownership of the user's account at the financial institution.

A better understanding of the above and other features and advantages of the novel account verification systems of the present invention may be obtained from a consideration of the detailed description of some example embodiments thereof presented below, particularly if such consideration is made in conjunction with the several views of the appended drawings, wherein like elements are referred to by like reference numerals throughout.

### BRIEF DESCRIPTION OF THE DRAWINGS

FIG. 1 is a diagram illustrating an example embodiment of a random deposit account verification (RDAV) system in accordance with the prior art;

FIG. 2 is a diagram illustrating an example embodiment of an instant account verification (IAV) system in accordance with the prior art;

FIG. 3 is a diagram illustrating an example embodiment of an instant account verification system in accordance with the present invention; and,

FIG. 4 is a diagram illustrating an example embodiment of an instant account verification method in accordance with the present invention.

### DETAILED DESCRIPTION

In accordance with the present disclosure, the existence and ownership of a user's account at a bank or other financial institution is verified using networked data processors to bypass the delay and expense of the conventional methods of “random deposit account verification” (RDAV), instant or “real time” account verification (IAV) and fee-for-service third party verification services by eliminating the web-page-based connection of the conventional method, and instead, connecting directly to the bank's account data server using a “Direct Connect” peer-to-peer (P2P) file-sharing protocol and the Open Financial Exchange (OFX) data-stream format.

Before a user, e.g., a buyer or a seller of goods or services, can use the services of an alternative payment service provider, such as PayPal, it is necessary for the user to first establish an account with that service provider. This is typically effected via the Internet, in a procedure in which the user logs onto the service provider's web server using a computer and web browser application, such as Microsoft's Internet Explorer, and provides the service provider with the user's identity, the name of the account holder as registered with a financial institution, such as a bank, credit union or the like, and typically, information relating to at least one account, which may be a checking, credit card or savings account, of the user at that financial institution, from which funds are to be withdrawn or to which funds are to be deposited in financial transactions mediated by the service provider on behalf of the user. For a bank, the account information provided typically includes at least the bank's routing number, the bank account number and the type of the account, i.e., checking, savings, investment, credit card or the like.

Additionally, before the user can effect a financial transaction utilizing the service provider, the service provider must “verify” the account identified by the user, i.e., must confirm that the identified account actually exists at the particular financial institution identified and that it is in fact owned by the user. This account verification can be effected in a number of ways, including by fee-for-service account verifying services, such as Yodlee, eCheck2000 and ACH-Works, but more typically, in one of two ways, viz., 1) random deposit account verification (RDAV), and 2) instant, or “real time,” account verification (IAV).

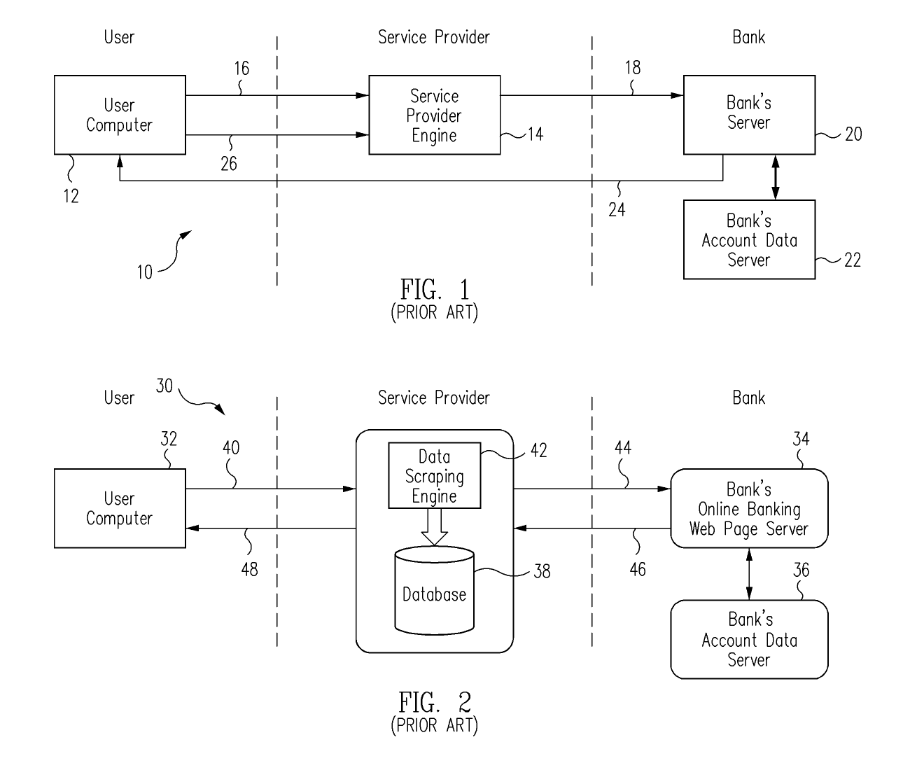

As illustrated in FIG. 1, in the conventional RDAV system 10, the user typically employs a computer 12, e.g., a personal computer (PC) running a web browser application, to log onto a web page provided by a web page server 14 of the service provider, and after providing the above user's financial account information, the user then sends an instruction 16 to the service provider to verify the account using the RDAV system 10. In response, the service provider proceeds to make one or more deposits 16 to the account identified by the user, which may be effected electronically, e.g., through the Electronic Clearing House (ECH) network via the bank's Electronic Funds Transfer (EFT) server 20.

Each deposit is typically less than a dollar, is made at random times and in random amounts, over a specified period of time, typically 5-7 days after the user provides the account information to the service provider. The bank credits the identified account with the deposits, records the amounts and dates of the deposits in the bank's account data server 22, and reports the dates and amounts of the deposits to the user, which may be by way of a conventional monthly paper statement mailed out by the bank, or alternatively, if the user has established “online banking” with the bank, by means of account data 24 downloaded from the bank's online banking web page server 20. After the deposits appear in the user's account, the user again logs onto the service provider server 14 and sends a message 24 to the service provider confirming the dates and the amounts of the random deposits, thereby verifying the existence and ownership of the account.

With reference to FIG. 2, the conventional IAV system 30 is available only where the user has previously established online banking with the bank or other financial institution, in which the user, as above, accesses the bank account via a web browser, or more typically, via a so-called “web scraping” application, such as Yodlee's online application, MoneyCenter, or Intuit's Quicken or QuickBooks, or Microsoft's Money, running on the user's computer 32. Web scraping applications process the hypertext markup language (HTML) of the web pages from the bank's web server 34 to extract financial data from the bank's account data server 36, almost universally formatted and transmitted from the account server using the Open Financial Exchange (OFX) financial data-stream specification discussed below, and then converts it to another format useful to the user, thereby simulating the user accessing the bank's web site via a web browser application.

Thus, as illustrated in FIG. 2, in the conventional IAV system 30, the user typically logs onto the service provider's web server with a computer 32, and in addition to providing the financial institution account information described above, the user also provides the service provider with the user's online banking login credentials, which typically include a user name and a password or personal identification number (PIN). The service provider may store the user's online banking login credentials in a local database 38, or alternatively, may only hold them temporarily in a memory device for a one-time verification use, after which they are erased or discarded.

The user then sends an instruction 40 to the service provider to verify the account using the IAV method 30. In response, the service provider retrieves the user's login credentials and, using a web scraping server and application, or “engine” 42, then uses the user's login credentials to simulate the user to establish a web page connection 44 with the bank's web page server 34, download account data 46 from the bank's account data server 36 verifying the existence and ownership of the account, and may also send a message 48 to the user that the account has been verified.

As those of skill in the art will appreciate, while the IAV system 30 is thus faster than the RDAV system 10 (i.e., “instant” or “real time” vs. a 5-7 day wait), it is less secure than the latter, which does not even require the user to have online banking, because it involves logging onto the user's online banking account via a web-page-based connection. Additionally, while the foregoing account verification systems are reasonably effective for their intended purpose, they are not without some associated transactional costs. For example, they are relatively expensive on a per account-verification basis, and while IAV system 30 is faster than RDAV system 10, it is also less secure than the latter.

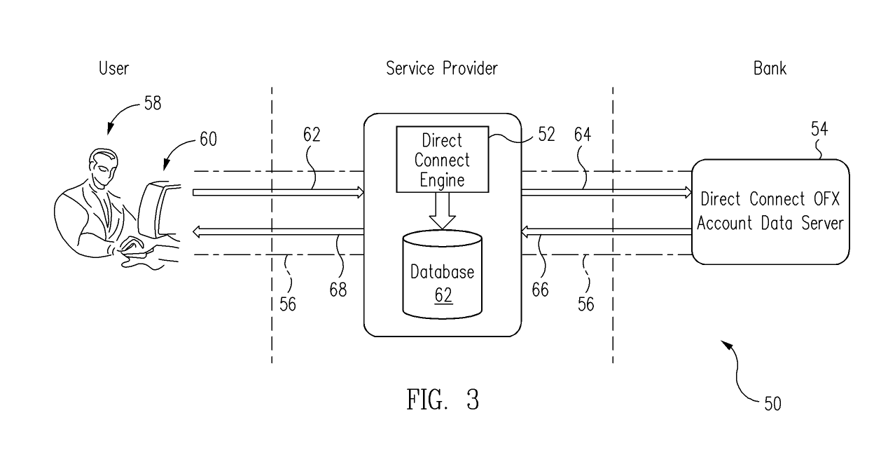

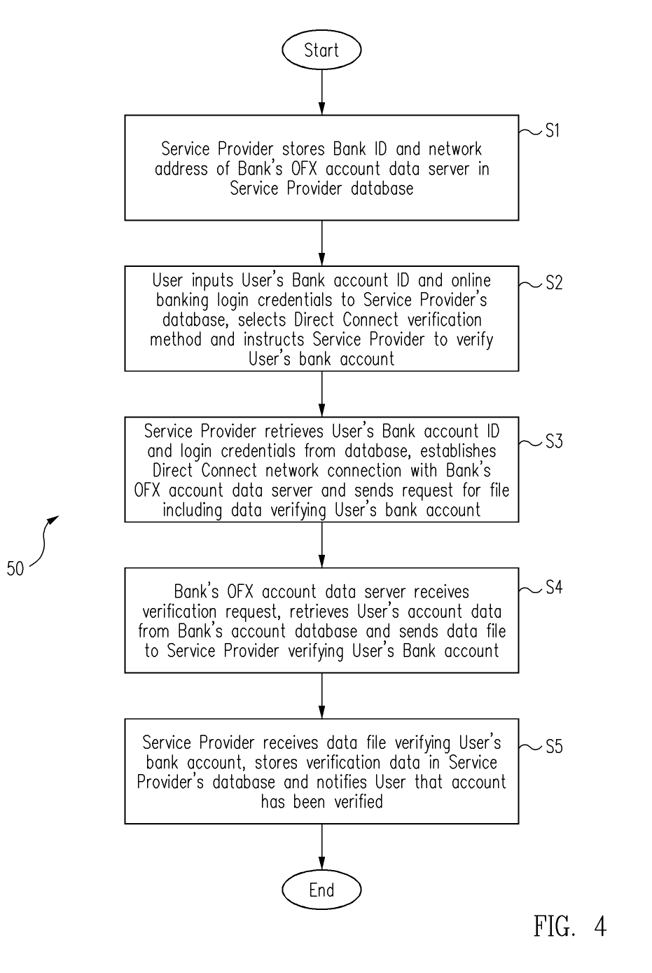

An example embodiment of an IAV or “OFX/Direct Connect” system 50 for instant account verification in accordance with the present invention which substantially overcomes the foregoing drawbacks of the conventional RDAV and IAV systems 10 and 30 above is illustrated in the diagrams of FIGS. 3 and 4.

As illustrated in FIGS. 3 and 4, the novel system 50 for verifying a user's account at a financial institution, such as a bank, comprises providing at least one data processor, typically a data server, or “engine” 52, of an alternative payment service provider, such as PayPal, that is programmably operable to communicate directly with a financial data server 54 of the bank via a data communication network 56, viz., the Internet. However, unlike the web scraping engines of the prior art systems described above, such as Intuit's Quicken or Microsoft's Money, the service provider's engine 52 is programmed to communicate directly with the bank's account data server 54 using an open source peer-to-peer (P2P) file-sharing connection protocol, viz., the Direct Connect file sharing protocol, with the data being formatted and exchanged in accordance with the “Open Financial Exchange” (OFX) specification for the exchange of financial data-streams.

As discussed above, OFX is a unified specification for the electronic exchange of financial data between financial institutions and consumers via the Internet that was developed and is promulgated and maintained currently by the “OFX Consortium,” which includes the Checkfree Corp., Intuit, Inc. and Microsoft, Inc. The OFX specification is the most widely adopted open standard for the exchange of financial data between consumers and financial service providers in the world and is currently used by more than 5,500 banks and other financial institutions, both in the U.S. and in other countries in Europe, South America and Australia.

Direct Connect is a P2P file-sharing protocol in which two “clients,” in this case, the service provider's Direct Connect data server 52, or engine and the bank's OFX account data server 54, each connect to a central hub (not illustrated), and then download files directly to and from one another, thereby eliminating the need to log onto the user's online banking account via a web-page-based engine or the need to develop a web scraping application that reformats the native OFX data files of the bank's account data server 54.

In the example embodiment 50 of FIGS. 3 and 4, and prior to commencement of an account verification procedure, the service provider first provisions a database 62 with information pertaining to the financial institution's identity and the network address of an account data server of the financial institution on a network, in this case, the Internet (S1 of FIG. 4). The former information may include at least one of the financial institution's identification number (FIID), organization code (ORG) and the financial institution's bank code (bankCode), and the latter may comprise a uniform resource locator (URL) of the data server on the Internet 56. The foregoing information and addresses can usually be obtained directly from the financial institutions themselves.

In addition, as in the conventional IAV system 30 discussed above, after establishing an account with the service provider, the user 58 also provides the service provider with information 62 that includes the user's identity, the name of the account holder as registered with a financial institution, and information pertaining to the user's account at the financial institution from which funds are to be withdrawn or to which funds are to be deposited by the service provider, along with the user's online banking login credentials at the financial institution (S2 of FIG. 4).

The user's account information provided may include at least one of the financial institution's routing number, the account number and the type of the account, i.e., checking, savings, investment, credit card or the like, and the user's online banking login credentials at the financial institution, which may include at least one of a user name, a user password and a user personal identification number (PIN).

In one embodiment, the user's online banking login credentials may be stored in the service provider's database 58 for future use, as discussed in more detail below, or alternatively, may be temporarily stored in a memory, used once for account verification, then erased or discarded after use.

After the user 58 inputs the user's account and online banking login credentials information 62 to the service provider, the user then sends an online instruction to the service provider to verify the account using the OFX/Direct Connect system 50.

Upon receipt of this instruction, the service provider uses the Direct Connect data engine 52 to retrieve the information pertaining to the financial institution's identity and the network address of the account data server of the financial institution on the network, as well as the user's account information and online banking login credentials at the financial institution, from the service provider's database 58 and/or temporary memory, and using that information, establishes a direct, OFX/Direct Connect P2P file-sharing connection with the financial institution's OFX based data server 54. The service provider then sends a request 64 to the financial institution's account data server over the network 56 for a data file that verifies at least the existence and ownership of the user's account (S3 of FIG. 4).

Upon receipt of the request 64, the financial institution's account data server 54 retrieves data from its accounts database pertaining to the user's account and sends a data file response 66 to the service provider's data engine 52 over the network 56 that includes data verifying at least the existence and ownership of the user's account at the financial institution (S4 of FIG. 4).

Upon receipt of the response 66 verifying the user's account, the service provider's data engine 52 may store the response in the service provider's database 62 for future reference, and the service provider may send a message 68 to the user 58 over the network 56 that the user's account has been successfully verified (S5 of FIG. 4).

Alternatively, if the financial institution's account data server 54 sends a response 66 that does not verify the user's account, e.g., responds with an error message, then the service provider may send a message to the user 58 advising of this and inviting the user to re-input some or all of the user's bank account information and/or online banking login credentials before attempting another attempt to verify the account.

As those of skill in the art will by now appreciate, the example OFX/Direct Connect system 50 described above provides several advantages over the conventional web-scraping IAV system 30, in that it is easier to implement and maintain, yet faster and more secure, due to the elimination of the web page based account access employed by the latter. Additionally, it is estimated that the new account verification system 50 can reduce the service provider's account verification costs substantially.

In addition to the foregoing, the example OFX/Direct Connect system 50 described above can provide other benefits to both users and service providers. For example, both the service provider and the user each will usually incur additional costs if the user attempts to effect a payment from an account in which there are insufficient funds (NSF). However, if a query as to the amount of funds currently in the user's account is included in the verification request 64, the financial account data server 54 will include that amount in the response 66. Thus, some user's may wish to store their online banking credentials in the service provider's database 62 and allow the service provider to both verify the account and ascertain that the account balance is sufficient to cover a particular transaction each time a transaction is made, in exchange for, e.g., a reduced per-transaction service charge by the service provider. In such an embodiment, both the user's account and the sufficiency of the funds in it are verified each time a transaction is made.

Although the methods and apparatus of the present invention have been described and illustrated herein with reference to certain specific example embodiments thereof, it should be understood that a wide variety of modifications and variations may be made to these without departing from the spirit and scope of the invention, as defined by the claims appended hereafter and their functional equivalents.

1. A method for verifying a user's account at a financial institution, the method comprising:
providing at least one data processor in communication with a data communication network; and,
using the at least one data processor to effect:
retrieving information pertaining to the user's account and online banking login credentials at the financial institution;
retrieving information pertaining to the financial institution's identity and the address of an account data server of the financial institution on the network;
establishing a direct connection with the account data server of the financial institution over the network using the financial institution's identity and account data server network address and the user's account information and online banking login credentials;
sending a request to the financial institution's account data server over the network using the connection for a data file that verifies at least the existence and ownership of the user's account; and,
receiving a response from the financial institution's account data server over the network of a data file verifying at least the existence and ownership of the user's account.

2. The method of claim 1, wherein the verification request and the response are respectively formatted and transmitted in accordance with the Open Financial Exchange (OFX) specification for the exchange of financial data.

3. The method of claim 1, wherein the direct connection is established using the Direct Connect point-to-point (P2P) file-sharing protocol.

4. The method of claim 1, wherein the network comprises the Internet.

5. The method of claim 1, wherein the user's account information comprises at least one of the group consisting of the financial institution's routing number, the account number and the account type.

6. The method of claim 1, wherein the user's online banking login credentials comprise at least one of the group consisting of a user name, a user password and a user personal identification number (PIN).

7. The method of claim 1, wherein the information pertaining to the financial institution's identity comprises at least one of the group consisting of the financial institution's identification number (FIID), organization code (ORG) and the financial institution's bank code (bankCode).

8. The method of claim 1, wherein the network address of the financial institution's account data server comprises a uniform resource locator (URL) of the account data server.

9. The method of claim 1, further comprising using the at least one data processor to store in and retrieve from a data storage device at least one of:
the information pertaining to the user's account and online banking login credentials at the financial institution; and,
the information pertaining to the financial institution's identity and the network address of the financial institution's account data server.

10. The method of claim 1, further comprising using the at least one data processor to effect:
sending a request to the financial institution's account data server over the network using the direct connection for a data file that includes the balance of funds in the user's account;
receiving a response from the financial institution's account data server over the network of a data file that includes the balance of funds in the user's account;
storing the response from the financial institution's financial data server in a storage device; and,
transmitting a message to the user over the network including at least one of that the user's account has been verified and the balance of funds in the user's account.

11. Apparatus for verifying a user's account at a financial institution, the apparatus comprising:
a data communication network; and,
at least one data processor in communication with the network and programmably operable to effect:
retrieving information pertaining to the user's account and online banking login credentials at the financial institution;
retrieving information pertaining to the financial institution's identity and the address of an account data server of the financial institution on the network;
establishing a direct connection with the account data server of the financial institution over the network using the financial institution's identity and account server network address and the user's account information and online banking login credentials;
sending a request to the financial institution's account data server over the network using the direct connection for a data file that verifies at least the existence and ownership of the user's account; and,
receiving a response from the financial institution's account data server over the network of a data file verifying at least the existence and ownership of the user's account.

12. The apparatus of claim 11, wherein the verification request and the reply are respectively formatted and transmitted in accordance with the Open Financial Exchange (OFX) specification for the exchange of financial data.

13. The apparatus of claim 11, wherein the direct connection is established using the Direct Connect point-to-point (P2P) file-sharing protocol.

14. The apparatus of claim 11, wherein the network comprises the Internet.

15. The apparatus of claim 11, wherein the user's account information comprises at least one of the group consisting of the financial institution's routing number, the account number and the account type.

16. The apparatus of claim 11, wherein the user's online banking login credentials comprise at least one of the group consisting of a user name, a user password and a user personal identification number (PIN).

17. The apparatus of claim 11, wherein the information pertaining to the financial institution's identity comprises at least one of the group consisting of the financial institution's identification number (FIID), organization code (ORG) and the financial institution's bank code (bankCode).

18. The apparatus of claim 11, wherein the network address of the financial institution's account data server comprises a uniform resource locator (URL) of the account data server.

19. The apparatus of claim 11, wherein the at least one data processor is further programmably operable to store in and retrieve from a data storage device at least one of:
the information pertaining to the user's account and online banking login credentials at the financial institution; and,
the information pertaining to the financial institution's identity and the network address of a financial data server of the financial institution.

20. The method of claim 11, wherein the at least one data processor is further programmably operable to effect:
sending a request to the financial institution's account data server over the network using the direct connection for a data file that includes the balance of funds in the user's account;
receiving a response from the financial institution's account data server over the network of a data file including the balance of funds in the user's account;
storing the response from the financial institution's account data server in a storage device; and,
transmitting a message to the user over the network including at least one of that the user's account has been verified and the balance of funds in the user's account.
